(19) United States
(12) Patent Application Publication
(10) Pub. No.: US 2026/0052420 A1
(43) Pub. Date: Feb. 19, 2026

(54) CHANNEL STATE INFORMATION REPORTING FOR MULTIPLE TRANSMISSION-RECEPTION POINTS

(71) Applicant: QUALCOMM Incorporated, San Diego, CA (US)

(72) Inventors: Jing DAI, Beijing (CN); Min HUANG, Beijing (CN); Chao WEI, Beijing (CN); Wei XI, Beijing (CN); Liangming WU, Beijing (CN); Hao XU, Beijing (CN)

(21) Appl. No.: 19/103,795

(22) PCT Filed: Nov. 1, 2022
(86) PCT No.: PCT/CN2022/128868

§ 371 Date: Feb. 13, 2025

(51) Int. Cl. H04W 24/10; H04B 7/024

(52) U.S. Cl. CPC H04W 24/10; H04B 7/024

(57) ABSTRACT

Methods, systems, and devices for operating a wireless device are described. A wireless device may include, according to a non-zero coefficient (NZC) splitting rule and in a first portion of a channel state information (CSI) report corresponding to a plurality of transmission-reception points (TRPs), first NZC information for a first set of TRPs, the first portion associated with a first priority level. The wireless device may include, according to the NZC splitting rule and in a second portion of the CSI report, second NZC information for a second set of TRPs, the second portion associated with a second priority level. The wireless device may include, in the CSI report and according to an additional channel state information splitting rule, additional channel state information for the plurality of TRPs.

### CROSS REFERENCE

This application is a 371 National Stage of PCT Application No. PCT/CN2022/128868, filed on Nov. 1, 2022, entitled “CHANNEL STATE INFORMATION REPORTING FOR MULTIPLE TRANSMISSION-RECEPTION POINTS”, and assigned to the assignee hereof. The disclosure of the prior application is considered part of and is incorporated by reference into this patent application.

### FIELD OF TECHNOLOGY

The following relates to operating a wireless device, including channel state information reporting for multiple transmission-reception points.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may communicate with multiple transmission-reception points. Improved techniques for reporting channel state information for multiple transmission-reception points may be desired.

### SUMMARY

The described techniques relate to improved methods, systems, devices, and apparatuses that support channel state information reporting for multiple transmission-reception points. A wireless device may determine channel state information (CSI) for multiple transmission-reception points that are in communication with the wireless device. The wireless device may split the channel state information for the multiple transmission-reception points between portions of a CSI report based on one or more CSI splitting rules.

A method for wireless communication is described. The method may include including, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level, including, according to the non-zero coefficient splitting rule and in a second portion of the channel state information report, second non-zero coefficient information for a second set of transmission-reception points of the set of multiple transmission-reception points, the second portion associated with a second priority level, including, in the channel state information report and according to an additional channel state information splitting rule, additional channel state information for the set of multiple transmission-reception points, and transmitting the channel state information report corresponding to the set of multiple transmission-reception points.

An apparatus for wireless communication is described. The apparatus may include a processor, memory coupled with the processor, and instructions stored in the memory. The instructions may be executable by the processor to cause the apparatus to include, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level, include, according to the non-zero coefficient splitting rule and in a second portion of the channel state information report, second non-zero coefficient information for a second set of transmission-reception points of the set of multiple transmission-reception points, the second portion associated with a second priority level, include, in the channel state information report and according to an additional channel state information splitting rule, additional channel state information for the set of multiple transmission-reception points, and transmit the channel state information report corresponding to the set of multiple transmission-reception points.

Another apparatus for wireless communication is described. The apparatus may include means for including, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level, means for including, according to the non-zero coefficient splitting rule and in a second portion of the channel state information report, second non-zero coefficient information for a second set of transmission-reception points of the set of multiple transmission-reception points, the second portion associated with a second priority level, means for including, in the channel state information report and according to an additional channel state information splitting rule, additional channel state information for the set of multiple transmission-reception points, and means for transmitting the channel state information report corresponding to the set of multiple transmission-reception points.

A non-transitory computer-readable medium storing code for wireless communication is described. The code may include instructions executable by a processor to include, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level, include, according to the non-zero coefficient splitting rule and in a second portion of the channel state information report, second non-zero coefficient information for a second set of transmission-reception points of the set of multiple transmission-reception points, the second portion associated with a second priority level, include, in the channel state information report and according to an additional channel state information splitting rule, additional channel state information for the set of multiple transmission-reception points, and transmit the channel state information report corresponding to the set of multiple transmission-reception points.

In some examples of the method, apparatuses, and non-transitory computer-readable medium described herein, the non-zero coefficient splitting rule indicates that a quantity of transmission-reception points in the first set of transmission-reception points corresponding to the first non-zero coefficient information may be to be equal to a quantity of transmission-reception points in the second set of transmission-reception points corresponding to the second non-zero coefficient information.

Some examples of the method, apparatuses, and non-transitory computer-readable medium described herein may further include operations, features, means, or instructions for selecting, based on the non-zero coefficient splitting rule, the first set of transmission-reception points and the second set of transmission-reception points so that the quantity of transmission-reception points in the first set of transmission-reception points may be equal to the quantity of transmission-reception points in the second set of transmission-reception points.

In some examples of the method, apparatuses, and non-transitory computer-readable medium described herein, the non-zero coefficient splitting rule indicates that non-zero coefficient information for a strongest transmission-reception point may be to be included in the first portion and that non-zero coefficient information for the remaining transmission-reception points of the set of multiple transmission-reception points may be to be included in the second portion.

Some examples of the method, apparatuses, and non-transitory computer-readable medium described herein may further include operations, features, means, or instructions for selecting the strongest transmission-reception point for the first set of transmission-reception points based on the non-zero coefficient splitting rule.

In some examples of the method, apparatuses, and non-transitory computer-readable medium described herein, the non-zero coefficient splitting rule indicates that a difference between a first quantity of spatial domain bases associated with the first set of transmission-reception points and a second quantity of spatial domain bases associated with the second set of transmission-reception points may be to be within a threshold difference.

Some examples of the method, apparatuses, and non-transitory computer-readable medium described herein may further include operations, features, means, or instructions for selecting, based on the non-zero coefficient splitting rule, the first set of transmission-reception points and the second set of transmission-reception points so that the difference between the first quantity of spatial domain bases and the second quantity of spatial domain bases may be within the threshold difference.

In some examples of the method, apparatuses, and non-transitory computer-readable medium described herein, the non-zero coefficient splitting rule indicates that a difference between a first quantity of non-zero coefficients associated with the first set of transmission-reception points and a second quantity of non-zero coefficients associated with the second set of transmission-reception points may be to be within a threshold difference.

Some examples of the method, apparatuses, and non-transitory computer-readable medium described herein may further include operations, features, means, or instructions for selecting, based on the non-zero coefficient splitting rule, the first set of transmission-reception points and the second set of transmission-reception points so that the difference between the first quantity of non-zero coefficients and the second quantity of non-zero coefficients may be within the threshold difference.

In some examples of the method, apparatuses, and non-transitory computer-readable medium described herein, the non-zero coefficient splitting rule indicates that some non-zero coefficients associated with a transmission-reception point of the set of multiple transmission-reception points may be to be included in the first portion and other non-zero coefficients associated with the transmission-reception point may be to be included in the second portion.

In some examples of the method, apparatuses, and non-transitory computer-readable medium described herein, the first non-zero coefficient information includes non-zero coefficients and a non-zero selection bitmap for the first set of transmission-reception points and the second non-zero coefficient information includes non-zero coefficients and a non-zero selection bitmap for the second set of transmission-reception points.

Some examples of the method, apparatuses, and non-transitory computer-readable medium described herein may further include operations, features, means, or instructions for determining that the first set of transmission-reception points may have stronger total power of non-zero coefficients than the second set of transmission-reception points, where the first non-zero coefficient information may be included in the first portion based on the first of transmission-reception points having stronger total power of non-zero coefficients than the second set of transmission-reception points.

Some examples of the method, apparatuses, and non-transitory computer-readable medium described herein may further include operations, features, means, or instructions for including, in a third portion of the channel state information report that may be associated with a third priority level higher than the first priority level and the second priority level, an indication of transmission-reception points included in the first set of transmission-reception points.

Some examples of the method, apparatuses, and non-transitory computer-readable medium described herein may further include operations, features, means, or instructions for including, in a third portion of the channel state information report that may be associated with a third priority level higher than the first priority level and the second priority level, an indication of a mapping order of the set of multiple transmission-reception points to the first non-zero coefficient information and the second non-zero coefficient information.

In some examples of the method, apparatuses, and non-transitory computer-readable medium described herein, the additional channel state information includes spatial domain basis information and the additional channel state information splitting rule indicates that the spatial domain basis information may be to be included in a third portion of the channel state information report that may be associated with a third priority level.

In some examples of the method, apparatuses, and non-transitory computer-readable medium described herein, the additional channel state information includes first spatial domain basis information for the first set of transmission-reception points and second spatial domain basis information for the second set of transmission-reception points and the additional channel state information splitting rule indicates that the first spatial domain basis information may be to be included in a same portion of the channel state information report as the first non-zero coefficient information, and indicates that the second spatial domain basis information may be to be included in a same portion of the channel state information report as the second non-zero coefficient information.

In some examples of the method, apparatuses, and non-transitory computer-readable medium described herein, the additional channel state information includes a quantity of spatial domain bases for the set of multiple transmission-reception points and the additional channel state information splitting rule indicates that the quantity spatial domain bases may be to be included a third portion of the channel state information report that may be associated with a third priority level.

In some examples of the method, apparatuses, and non-transitory computer-readable medium described herein, the additional channel state information includes second spatial domain basis information for the set of multiple transmission-reception points and the additional channel state information splitting rule indicates that the second spatial domain basis information may be to be split between the first portion and the second portion.

In some examples of the method, apparatuses, and non-transitory computer-readable medium described herein, the additional channel state information includes frequency domain basis information for the set of multiple transmission-reception points and the additional channel state information splitting rule indicates that the frequency domain basis information may be to be included in the first portion if a frequency domain joint codebook may be in use.

In some examples of the method, apparatuses, and non-transitory computer-readable medium described herein, the additional channel state information includes frequency domain basis information for the set of multiple transmission-reception points, the additional channel state information splitting rule indicates that the frequency domain basis information may be to be included in a third portion of the channel state information report if a port-selection codebook may be in use, and the third portion may be associated with a third priority level.

In some examples of the method, apparatuses, and non-transitory computer-readable medium described herein, the additional channel state information includes frequency domain basis information for the set of multiple transmission-reception points and the additional channel state information splitting rule indicates that the frequency domain basis information may be to be split between the first portion and the second portion if a frequency domain independent codebook may be in use.

In some examples of the method, apparatuses, and non-transitory computer-readable medium described herein, the additional channel state information includes first frequency domain compensation information for the first set of transmission-reception points and second frequency domain compensation information for the second set of transmission-reception points and the additional channel state information splitting rule indicates that the first frequency domain information may be to be included in a same portion of the channel state information report as the first non-zero coefficient information and the second frequency domain information may be to be included in a same portion of the channel state information report as the second non-zero coefficient information.

### BRIEF DESCRIPTION OF THE DRAWINGS

FIG. 1 illustrates an example of a wireless communications system that supports channel state information reporting for multiple transmission-reception points in accordance with one or more aspects of the present disclosure.

FIG. 2 illustrates an example of a wireless communications system that supports channel state information reporting for multiple transmission-reception points in accordance with one or more aspects of the present disclosure.

FIG. 3 illustrates an example of a report that supports channel state information reporting for multiple transmission-reception points in accordance with one or more aspects of the present disclosure.

FIG. 4 illustrates an example of a report that supports channel state information reporting for multiple transmission-reception points in accordance with one or more aspects of the present disclosure.

FIG. 5 illustrates an example of a report that supports channel state information reporting for multiple transmission-reception points in accordance with one or more aspects of the present disclosure.

FIGS. 6 and 7 illustrate block diagrams of devices that support channel state information reporting for multiple transmission-reception points in accordance with one or more aspects of the present disclosure.

FIG. 8 illustrates a block diagram of an CSI report component that supports channel state information reporting for multiple transmission-reception points in accordance with one or more aspects of the present disclosure.

FIG. 9 illustrates a diagram of a system including a device that supports channel state information reporting for multiple transmission-reception points in accordance with one or more aspects of the present disclosure.

FIG. 10 illustrates a flowchart showing methods that support channel state information reporting for multiple transmission-reception points in accordance with one or more aspects of the present disclosure.

### DETAILED DESCRIPTION

In some wireless communication systems, a user equipment (UE) may transmit channel state information (CSI) for a transmission-reception point (TRP) to a network entity associated with the TRP. For example, a UE may transmit CSI for a TRP in a CSI report. The CSI may be divided into different portions of the CSI report that are associated with different priority levels (e.g., omission priority levels). But the techniques for dividing the CSI for a single TRP (sTRP) between portions of a CSI report may be inadequate in a multi-TRP (mTRP) scenario in which the UE transmits CSI for multiple TRPs in communication with the UE.

The techniques described herein may support the division of CSI for multiple TRPs (referred to as mTRP CSI) between portions of a CSI report. For example, a UE may follow the techniques described herein to divide between portions of a CSI report various CSI for multiple TRPs, such as non-zero coefficient (NZC) information, spatial domain (SD) basis information, frequency domain (FD) basis information, and frequency domain compensation information.

For example, the UE may divide the NZC information for multiple TRPs between portions of a CSI report based on the quantity of TRPs, based on the strength of the TRPs (e.g., a measured signal or channel strength associated with the TRP), based on the spatial domain bases for the TRPs, or based on the quantity of NZCs for the TRPs. The UE may indicate the TRPs associated with the NZC information in each portion of the CSI report so that the network device is able to match the NZC information to the correct TRP.

The UE may divide the spatial domain basis information for multiple TRPs between portions of a CSI report so that the spatial domain basis information for each TRP is in the same portion as the NZC information for that TRP. Alternatively, the UE may include the spatial domain basis information for each of the multiple TRPs in a highest priority portion (e.g., portion 0) of the CSI report. Alternatively, the UE may include some of the spatial domain basis information for each of the multiple TRPs in the highest priority portion of the CSI report and may include the remaining spatial domain basis information for each TRP in the same portion of the CSI report as the NZC information for that TRP.

The UE may divide the frequency domain basis information for multiple TRPs between portions of a CSI report based on the type of codebook used by the UE. For example, the UE may include the frequency domain basis information for each TRP in the highest priority portion (e.g., portion 0) if the UE uses a port-selection codebook. As another example, the UE may include the frequency domain basis information for each TRP in the intermediate priority portion (e.g., portion 1) of the CSI report if the UE uses a mode 2 FD-joint codebook. As another example, the UE may include the frequency domain basis information for each TRP in the same portion of the CSI report as the NZC information for that TRP if the UE uses a mode 1 FD-independent codebook. The UE may include the frequency domain compensation information for each TRP in the same portion of the CSI report as the NZC information for that TRP.

Aspects of the disclosure are initially described in the context of wireless communications systems. Aspects of the disclosure are then described in the context of CSI reports. Aspects of the disclosure are further illustrated by and described with reference to apparatus diagrams, system diagrams, and flowcharts that relate to channel state information reporting for multiple transmission-reception points.

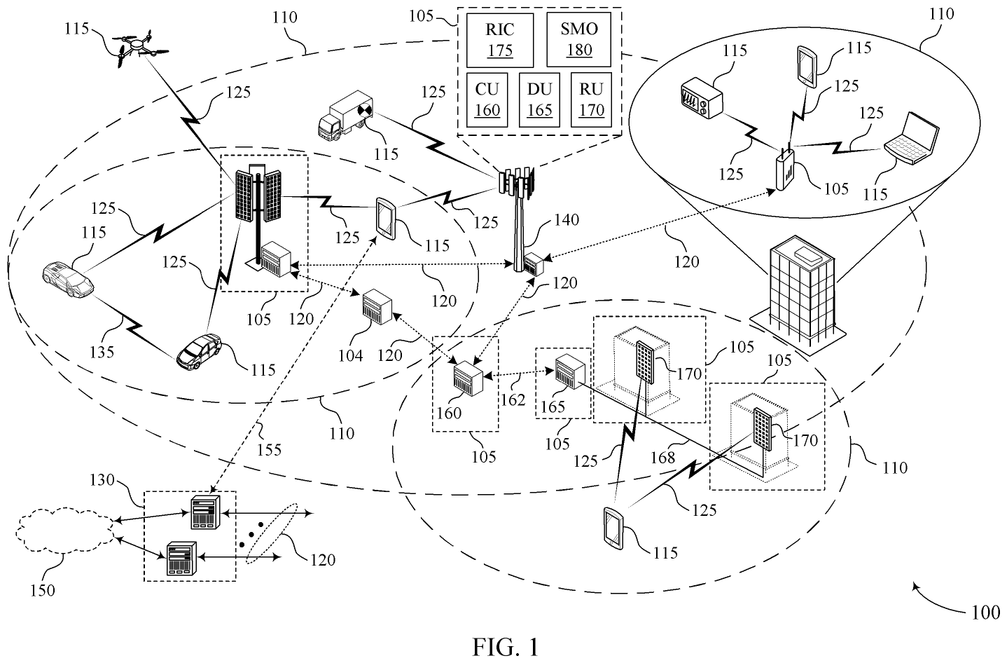

FIG. 1 illustrates an example of a wireless communications system 100 that supports channel state information reporting for multiple transmission-reception points in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission-reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support channel state information reporting for multiple transmission-reception points as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₙₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a UE 115 may support mTRP operations. In mTRP operation, the UE 115 may communicate with two or more co-located or distribute (e.g., physically separated) TRPs that are associated with a single serving cell of a network entity. For example, the UE 115 may communicate with multiple (e.g., four) TRPs using coherent joint transmission (CJT) techniques in which data is precoded jointly on different TRPs.

The UE 115 may use different codebooks for different deployment scenarios. In some examples (e.g., if two or more TRPs are co-located), the UE 115 may use a mode 2 codebook (also referred to as a FD-joint codebook) in which the precoder W for one layer is a function of the spatial domain bases for the TRPs (denoted W_{1,n} for TRP n), the non-zero coefficient (NZC) matrices for the TRPs (denoted W_{2,n}) for TRP n, and the frequency domain basis shared by the TRPs (denoted W_{f,H}). In other examples (e.g., if two or more TRPs are distributed), the UE 115 may use a mode 1 codebook (also referred to as an FD-independent codebook) in which the precoder W for one layer is a function of the spatial domain bases for the TRPs, the NZC matrices for the TRPs, and the frequency domain bases for the TRPs (denoted W_{f,n} for TRP n). The spatial domain basis for a TRP may be associated with or representative of a direction of the channel between that TRP and the UE 115, whereas the frequency domain basis for a TRP may be associated with or representative of a delay of the channel between that TRP and the UE 115.

In mTRP operation, the UE 115 may transmit CSI for the TRPs involved in the mTRP operation. The CSI for the TRPs may be included in a CSI report that is transmitted over a control channel such as the physical uplink control channel (PUCCH). Due to the size of the CSI report, the UE 115 may split the CSI report into two parts: part 1 and part 2. Part 1 of the CSI report may include rank indicator (RI) information, channel quality index (CQI) information, and an indication of NZC quantity (e.g., the total number of NZCs across all layers). Part 2 of the CSI report may include strongest coefficient indicator (SCI) information, spatial domain basis information, frequency domain basis information, and NZC information, among other information. Part 1 may have a fixed payload, which may be smaller than the payload size of part 2, and may be transmitted with higher reliability than part 2. CSI may also be referred to as uplink control information (UCI) or other suitable terminology.

In some examples, a UE 115 may divide the information in part 2 of the CSI report between portions of the CSI report that are assigned different priority levels (e.g., omission priority levels). For example, in sTRP operation, the UE 115 may divide NZC information in the frequency domain. But the division techniques used for sTRP operation may be inappropriate for mTRP operation. For example, using the frequency domain as the basis for dividing CSI between portions of a CSI report may be inappropriate in mTRP operation because in mTRP operation, different TRPs may have different most significant frequency domain basis, which may or may not be reported. Further, in mTRP operation (e.g., if the UE uses a FD-independent codebook), different TRPs may have different frequency domain bases selected, rendering frequency domain-based division challenging.

A UE 115 may use the CSI splitting rules described herein to divide CSI for multiple TRPs between portions of a CSI report using one or more bases more suited to mTRP operation (e.g., based on spatial domain basis, based on TRP index, based on TRP power). In some examples, the UE 115 may implement the CSI splitting rules described herein based on the UE 115 operating with Type II coherent joint transmission (CJT) codebook. The CSI splitting rules may include an NZC splitting rule and one or more additional CSI splitting rules, such as an SD basis splitting rule, an FD basis splitting rule, or an FD compensation splitting rule.

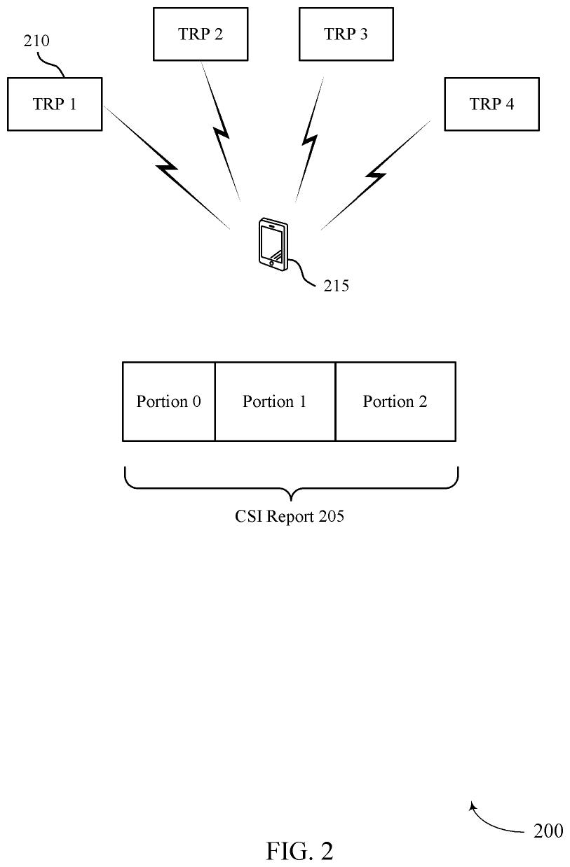

FIG. 2 illustrates an example of a wireless communications system 200 that supports channel state information reporting for multiple transmission-reception points in accordance with one or more aspects of the present disclosure. In some examples, the wireless communications system 200 may implement aspects of the wireless communications system 100. For example, the wireless communications system 200 may include a UE 215, which may be an example of a UE 115 as described with reference to FIG. 1. The UE 215 may communicate with multiple TRPs 210 using coherent joint transmission techniques (e.g., Type II CJT). The TRPs 210 may be associated with a common serving cell or network entity and may be co-located or distributed.

The UE 215 may determine CSI information for the TRPs 210 (e.g., based on respective reference signals received from the TRPs 210) and provide the CSI information for the TRPs 210 to the network entity associated with the TRPs 210. For example, the UE 215 may determine NZC information for TRP 1 (e.g., one or more NZCs, an NZC selection bitmap), SD information for TRP 1 (e.g., SD basis selection information), FD information for TRP 1 (e.g., FD basis selection information), and FD compensation information (e.g., FD compensation phase(s) relative to a reference TRP) for TRP 1. The UE 215 may determine similar CSI for TRP 2, TRP 3, and TRP 4. The quantity of TRPs for which the UE 215 provides CSI may be configured at the UE 215 (e.g., by the network device) or selected autonomously by the UE 215.

The UE 215 may use the CSI splitting rules described herein to divide the CSI for the TRPs 210 between portions of the CSI report 205, which may be an example of part 2 of a CSI report. Each portion of the CSI report 205 may be associated with a respective priority level, such as an omission priority level for omitting that portion from the CSI report. For instance, CSI report 205 may include portion 0, which may be associated with a first priority level (e.g., a highest priority level), portion 1 which may be associated with a second priority level (e.g., an intermediate priority level), and portion 2, which may be associated with a third priority level (e.g., a lowest priority level). A portion of the CSI report 205 may also be referred to a group of the CSI report or other suitable terminology. Thus, CSI report 205 may include group 0, group 1, and group 2.

The UE 215 may divide the NZC information for the TRPs 210 between the portions of the CSI report 205 based on (e.g., according to) an NZC splitting rule. In some examples, the NZC splitting rule may indicate that the NZC information (e.g., NZCs, NZC selection bitmaps) for the TRPs 210 is to be divided between the portions of the CSI report 205 so that the NZC information for half the TRPs (or nearly half the TRPs) in is portion 1 and the NZC information for the other half of the TRPs is in portion 2. Put another way, the NZC splitting rule may indicate that the quantity of TRPs associated with the NZC information in portion 1 is equal to or nearly equal to the quantity of TRPs associated with the NZC information in portion 2. Put another way, the NZC splitting rule may indicate that a difference between the quantity of TRPs associated with the NZC information in portion 1 and the quantity of TRPs associated with the NZC information in portion 2 is to be less than or equal to a threshold difference (e.g., the smallest difference possible given the total quantity of TRPs 210).

As an illustration, the NZC information for two TRPs (e.g., TRP 1 and TRP 2) may be included in portion 1 and the NZC information for two other TRPs (e.g., TRP 3, TRP 4) may be included in portion 2. In some examples, the UE 215 may select the TRPs for portion 1 based on the strength of the TRPs. For instance, the UE 215 may select TRP 1 for portion 1 based on TRP 1 being the strongest TRP. The strongest TRP may be the TRP with the largest total power of the NZCs (e.g., the squared summation of the NZC amplitudes) or the TRP associated with the SCI. As another example, the UE 215 may select for portion 1 the TRPs 210 that have stronger total power of NZCs relative to the other TRPs 210. Thus, in some examples, the TRPs associated with the NZC information included in portion 1 may have higher power than the TRPs associated with the NZC information included in portion 2.

In an alternative, the NZC splitting information may indicate that the NZC information for the TRPs 210 is to be divided between portions of the CSI report 205 so that the NZC information for the strongest TRP is in portion 1 and the NZC information for the remaining TRPs is in portion 2. For example, if TRP 1 is the strongest TRP, the UE 215 may include the NZC information for TRP 1 in portion 1 and may include the NZC information for TRP 2, TRP 3, and TRP 4 in portion 2.

In an alternative, the NZC splitting information may indicate that the NZC information for the TRPs 210 is to be divided between portions of the CSI report 205 so that the quantity of SD bases associated with the TRPs corresponding to the NZC information in portion 1 is equal or nearly equal to (e.g., within a threshold range of) the quantity of SD bases associated with the TRPs corresponding to the NZC information in portion 2. Put another way, the NZC splitting information may indicate that a difference between the quantity of SD bases associated with the TRPs corresponding to the NZC information in portion 1 and the quantity of SD bases associated with the TRPs corresponding to the NZC information in portion 2 is less than or equal to a threshold difference (e.g., the smallest difference possible give the total quantity of SD bases).

As an illustration, if Lₙ is the quantity of SD bases selected for TRP n, the UE 215 may split the NZC information for the TRPs 210 between portion 1 and portion 2 so that the sum of SD bases associated with the NZC information in portion 1 is equal or nearly equal to the sum of SD bases associated with the NZC information in portion 2 (e.g., Σₙ₌₁²Ln=Σₙ₌₃⁴Ln). As an illustration, if TRP 1 and TRP 3 are each associated with five SD bases and TRP 2 and TRP 4 are each associated with two SD bases, the UE 215 may include NZC information for TRP 1 and TRP 2 in portion 1 and may include NZC information for TRP 3 and TRP 4 in portion 2 (so that the quantity of SD bases associated with the NZC information in each portion is equal to seven).

In an alternative, the NZC splitting information may indicate that the NZC information for the TRPs 210 is to be divided between portions of the CSI report 205 so that the quantity of NZCs in portion 1 is equal or nearly equal to (e.g., within a threshold range of) the quantity of NZCs in portion 2. Put another way, the NZC splitting information may indicate that a difference between the quantity of NZCs in portion 1 and the quantity of NZCs in portion 2 is less than or equal to a threshold difference (e.g., the smallest difference possible give the total quantity of NZCs).

As an illustration, if

$${K}_{NZC , n}^{tot}$$

is the quantity of NZCs for TRP n, the UE 215 may split the NZC information for the TRPs 210 between portion 1 and portion 2 so that the sum of NZCs for the TRPs in portion 1 is equal or nearly equal to the sum of NZCs for the TRPs in portion 2

$$( e . g . , {\sum }_{n = 1}^{2} {K}_{NZC , n}^{tot} = {\sum }_{n = 3}^{4} {K}_{NZC , n}^{tot} ) .$$

As an illustration, if TRP 1 and TRP 3 are each associated with four NZCs and TRP 2 and TRP 4 are each associated with three NZCs, the UE 215 may include NZC information for TRP 1 and TRP 2 in portion 1 and may include NZC information for TRP 3 and TRP 4 in portion 2 (so that the quantity of NZCs for the TRPs in each portion is equal to seven).

In some examples, the NZCs for a TRP may be split between portions of the CSI report 205 to improve the balance between NZCs in the portions. For example, some of the NZCs for TRP n may be included in portion 1 and other NZCs for this TRP n may be included in portion 2. In such an example, the NZCs for each TRP in the remaining TRPs 210 may be included in portion 1 or portion 2 (but not both) based on the NZC splitting rule. Further, the other CSI (e.g., SD basis information, FD basis information, FD compensation information) for TRP n may be included in portion 1. In some examples, a frequency domain permutation (e.g., an FD basis index permutation) may be applied to the NZCs of TRP n. In other examples, no frequency domain permutation may be applied to the NZCs of TRP n.

The UE 215 may indicate the relationship between TRPs 210 and the NZC information in the CSI report 205. For example, the UE 215 may include in portion 0 one or more bits that indicate which NZC information belongs to which TRP. If the NZC information for the TRP associated with the SCI is included in portion 1 (e.g., as a default or according to the NZC splitting rule), the UE 215 may indicate the other TRPs associated with the NZC information.

In a first example, the UE 215 may include a codepoint of two or more bits that indicates the TRP(s) (other than the SCI TRP) corresponding to the NZC information in portion 1. For instance, the UE 215 may transmit a codepoint of two bits (b0, b1) that indicates the TRP corresponding to the NZC information in portion 1, or the UE 215 may transmit a codepoint of three bits (b0, b1, b2) that indicates the TRPs corresponding to the NZC information in portion 1.

In a second example, the UE 215 may include a codepoint of two or more bits that indicates an ordering of the TRPs (other than the SCI TRP) relative to the NZC information in the CSI report 205. For instance, the UE 215 may include a codepoint that maps the TRPs to the NZC information in the CSI report 205. The codepoint may indicate the TRP corresponding to the first NZC information (e.g., after the NZC information corresponding to the SCI TRP) in the CSI report 205, the TRP corresponding to the second NZC information in the CSI report 205, and the TRP corresponding to the third NZC information in the CSI report 205.

The UE 215 may divide the SD basis information for the TRPs 210 between the portions of the CSI report 205 based on (e.g., according to) an SD splitting rule. In some examples, the SD splitting rule may indicate that the SD basis information (e.g., the quantity of SD bases, SD basis selection) for the TRPs 210 is to be included in portion 0 of the CSI report 205. In an alternative, the SD splitting rule may indicate that the SD basis information for a TRP 210 is to be included in the same portion of the CSI report 205 as the NZC information for that TRP 210. For example, if the NZC information for TRP 1 is in portion 1, the UE 215 may also include the SD basis information for TRP 1 in portion 1. Thus, the SD basis information for a TRP 210 may follow the NZC information for the TRP 210.

In an alternative, the SD splitting rule may indicate that first SD basis information is to be included in portion 0 whereas second SD basis information is to be split between portion 1 and portion 2. For instance, the SD splitting rule may indicate that the quantity of SB bases (e.g., Lₙ) for each TRP 210 is to be included in portion 0, whereas the main part of SD basis selection for a TRP 210 is to follow the NZC information for that TRP 210. For example, for TRP n, an indication of

$$⌈ {log}_{2} ( \begin{matrix}{N}_{1} {N}_{2} \\ {L}_{n}\end{matrix} ) ⌉$$

bits and/or an indication of log₂ O₁O₂ bits may be included in the same portion as the NZC information for TRP n, where N₁N₂ is the total number of ports for each TRP, and O₁O₂ is the total number of spatial-domain oversampling groups.

To illustrate, if the NZC information for TRP 1 is included in portion 1 and the NZC information for TRP 3 is included in portion 2, the UE 215 may include the quantity of SB bases for TRP 1 (e.g., L₁) and the quantity of SB bases for TRP 3 (e.g., L3) in portion 0. Further, the UE 215 may include the main part of SD basis selection for TRP 1 in portion 1 and may include the main part of SD basis selection for TRP 3 in portion 2.

The UE 215 may divide the FD basis information for the TRPs 210 between the portions of the CSI report 205 based on (e.g., according to) an FD splitting rule. In some examples, the FD splitting rule may indicate that the FD basis information is to be included in the CSI report 205 based on the codebook used by the UE 215. For example, the FD splitting rule may indicate that the FD basis information for the TRPs 210 is to be included in portion 0 of the CSI report 205 if the UE 215 uses a port-selection codebook. The FD splitting rule may indicate that the FD basis information for the TRPs 210 is to be included in portion 1 of the CSI report 205 if the UE 215 uses a FD-joint codebook (e.g., a mode 2 FD-joint codebook). The FD splitting rule may indicate that the FD basis information for a TRP 210 is to be included in the same portion of the CSI report 205 as the NZC information for that TRP 210 if the UE 215 uses a FD-independent codebook.

The UE 215 may divide the FD compensation information for the TRPs 210 between the portions of the CSI report 205 based on (e.g., according to) a FD compensation splitting rule. In some examples, the FD compensation splitting rule may indicate that the FD compensation information for a TRP 210 (e.g., the FD compensation phase ΔØn for TRP n) is to be included in the same portion of the CSI report 205 as the NZC information for that TRP 210. The FD compensation phase for a TRP may be the difference in phase between that the TRP and a reference TRP (e.g., the SCI TRP).

Thus, the UE 215 may use the CSI splitting rules described herein to divide CSI for multiple TRPs 210 between portions of a CSI report 205. In some examples, the UE 215 may use the CSI splitting rules based on the UE 215 using mTRP operations, based on the UE 215 using coherent joint transmissions (e.g., Type 2 CJT), or both. If the UE 215 falls back to sTRP operations in which the UE 215 reports CSI for a single TRP, the UE 215 may split the NZC information for the TRP between portion 1 and portion 2 so that some (e.g., a first half) of the NZCs for the TRP are included in portion 1 and so that some (e.g., a second half) of the NZCs for the TRP are included in portion 2. For example, the highest priority NZCs for the TRP may be included in portion 1 and the lowest priority NZCs may be included in portion 2.

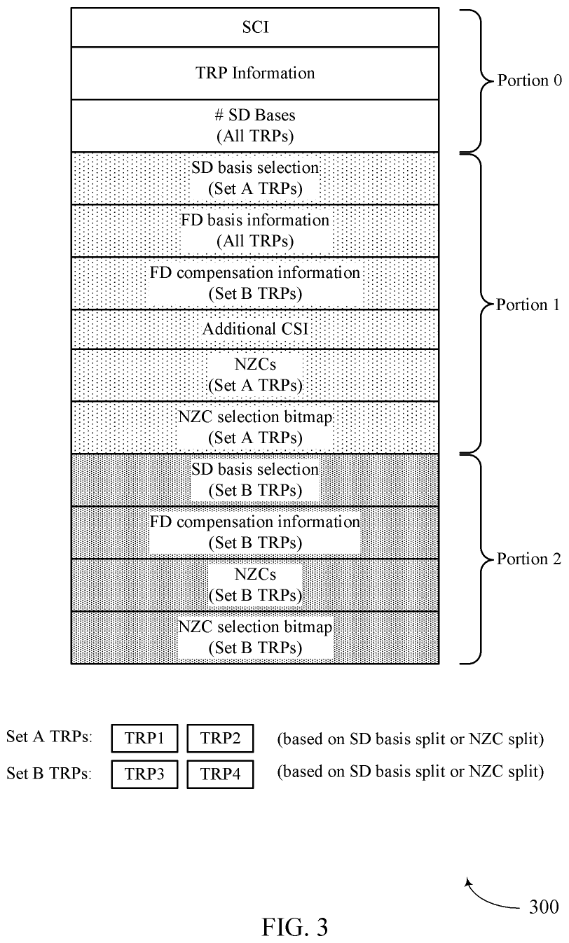

FIG. 3 illustrates an example of a CSI report 300 that supports channel state information reporting for multiple transmission-reception points in accordance with one or more aspects of the present disclosure. The CSI report 300 may be an example of the CSI report 205 as described with reference to FIG. 2. The CSI report 300 may be transmitted by a UE such as a UE 115 or a UE 215 as described with reference to FIGS. 1 and 2, respectively. The UE may be in an mTRP mode in which the UE communicates with multiple TRPs using coherent joint transmission techniques (e.g., Type II CJT). The TRPs may be associated with a common serving cell or network entity and may be co-located or distributed.

The UE may include CSI for the multiple TRPs in different portions of the CSI report 300 according to a first combination of CSI splitting rules. In portion 0 of the CSI report 300, the UE may provide information about how the TRPs map to the CSI that is split between the portions. For example, the UE may include an indication of the TRPs in set A and set B so that the network entity can determine the TRP corresponding to the CSI in each portion. For example, the UE may include in portion 0 one or more bits that indicate which NZC information belongs to which TRP. In some examples, the UE may also include in portion 0 the SCI information for one or more of the TRPs (e.g., the SCI for the strongest TRP).

The UE may divide the NZC information for the TRPs according to an NZC splitting rule. In the provided example, the UE may divide the NZC information for the TRPs so that NZC information corresponding to a first set of the TRPs (e.g., set A) is included in portion 1 and so that NZC information corresponding to a second set of the TRPs (e.g., set B) is included in portion 2. In the given example, set A may include TRP 1 and TRP 2, and set B may include TRP 3 and TRP 4. So, in CSI report 300, the NZCs and NZC selection bitmap(s) for set A TRPs may be included in portion 1, and the NZCs and NZC selection bitmap(s) for set B TRPs may be included in portion 2.

The bits of the NZC selection bitmap(s) for set A may be given by the formula Σ_{n∈SetA}2LₙMₙ, where Lₙ is the quantity of SD bases selected for TRP n, and Mₙ is the quantity of FD bases selected for TRP n. The bits of the NZC selection bitmap(s) for set B may be given by the formula Σ_{n∈SetB} 2LₙMₙ.

The UE may select the TRPs for set A and set B based on the NZC splitting rule, which may indicate that the NZC information for the TRPs is to be divided between portions of the CSI report 300 so that the quantity of SD bases associated with the TRPs corresponding to the NZC information in portion 1 is equal or nearly equal to (e.g., within a threshold range of) the quantity of SD bases associated with the TRPs corresponding to the NZC information in portion 2. Alternatively, the NZC splitting rule may indicate that the NZC information for the TRPs is to be divided between portions of the CSI report 300 so that the quantity of NZCs in portion 1 is equal or nearly equal to (e.g., within a threshold range of) the quantity of NZCs in portion 2.

The UE may divide the SD basis information for the TRPs according to an SD basis splitting rule that indicates that the quantity of SB bases (e.g., Lₙ) for each TRP is to be included in portion 0, whereas the main part of SD basis selection (e.g., the selected SD basis/bases) for a TRP is to follow (e.g., be in the same portion as) the NZC information for that TRP. So, in CSI report 300, the quantity of SD bases for each TRP is included in portion 0, the SD basis selection for set A TRPs is included in portion 1 (which has the NZC information for set A TRPs), and the SD basis selection for set B TRPs is included in portion 2 (which has the NZC information for set B TRPs).

The UE may divide the FD basis information for the TRPs according to an FD basis splitting rule that indicates that the FD basis information for the TRPs is to be included in portion 1 of the CSI report 300 if the UE uses an FD-joint codebook (e.g., a mode 2 FD-joint codebook). So, referring to CSI report 300, the UE may include the FD basis information for the TRPs in portion 1 based on the UE using a mode 2 FD-joint codebook.

The UE may divide the FD compensation information for the TRPs according to an FD compensation splitting rule that indicates that the FD compensation information for each TRP is to be included in the same portion of the CSI report 300 as the NZC information for that TRP. So, referring to CSI report 300, the UE may include the FD compensation information for TRP 1 and TRP 2 in portion 1 based on the NZC information for TRP 1 and TRP 2 being included in portion 1. Similarly, the UE may include the FD compensation information for TRP 3 and TRP 4 in portion 2 based on the NZC information for TRP 3 and TRP 4 being included in portion 2.

In some examples, the UE may include additional CSI in portion 1. For example, the UE may include reference amplitude information for the weaker polarization of the two polarizations in portion 1.

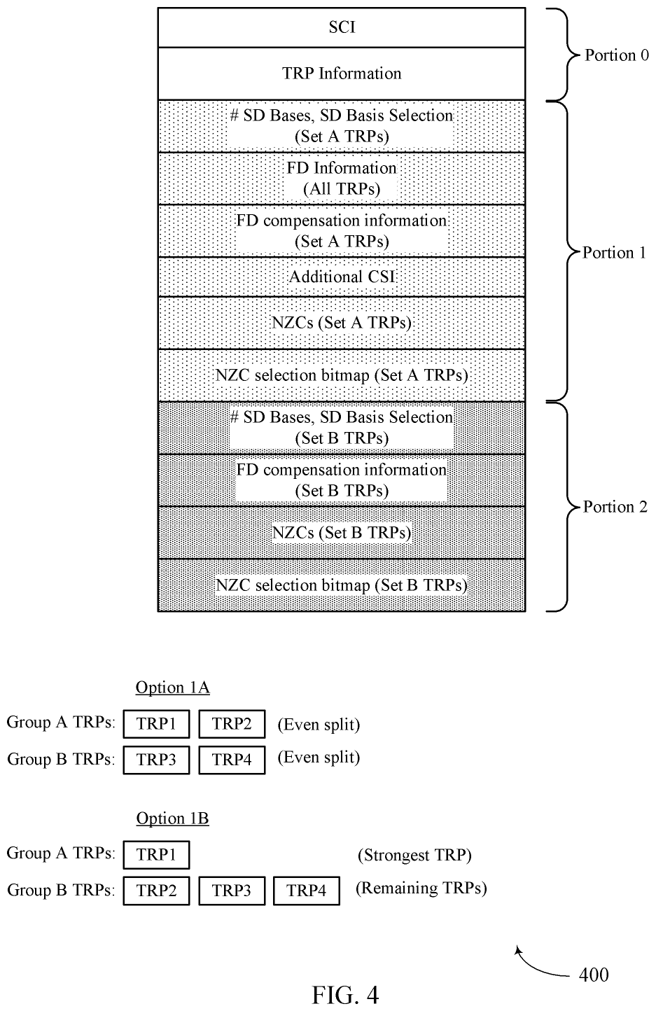

FIG. 4 illustrates an example of a CSI report 400 that supports channel state information reporting for multiple transmission-reception points in accordance with one or more aspects of the present disclosure. The CSI report 400 may be an example of the CSI report 205 as described with reference to FIG. 2. The CSI report 400 may be transmitted by a UE such as a UE 115 or a UE 215 as described with reference to FIGS. 1 and 2, respectively. The UE may be in an mTRP mode in which the UE communicates with multiple TRPs using coherent joint transmission techniques (e.g., Type II CJT). The TRPs may be associated with a common serving cell or network entity and may be co-located or distributed.

The UE may include CSI for the multiple TRPs in different portions of the CSI report 400 according to a second combination of CSI splitting rules. In portion 0 of the CSI report 400, the UE may provide information about how the TRPs map to the CSI that is split between the portions. For example, the UE may include an indication of the TRPs in set A and set B so that the network entity can determine the TRP corresponding to the CSI in each portion. For example, the UE may include in portion 0 one or more bits that indicate which NZC information belongs to which TRP. In some examples, the UE may also include in portion 0 the SCI information for one or more of the TRPs (e.g., the SCI for the strongest TRP).

The UE may divide the NZC information for the TRPs according to an NZC splitting rule. In the provided example, the UE may divide the NZC information for the TRPs so that NZC information corresponding to a first set of the TRPs (e.g., set A) is included in portion 1 and so that NZC information corresponding to a second set of the TRPs (e.g., set B) is included in portion 2. In one example (e.g., in Option 1A), set A may include TRP 1 and TRP 2, and set B may include TRP 3 and TRP 4. In another example (e.g., in Option 1), set A may include TRP 1, and set B may include TRP 2, TRP 3, and TRP 4. So, in CSI report 400, the NZCs and NZC selection bitmap(s) for set A TRPs may be included in portion 1, and the NZCs and NZC selection bitmap(s) for set B TRPs may be included in portion 2.

The UE may select the TRPs for set A and set B based on the NZC splitting rule. In one example (e.g., Option 1A), the NZC splitting rule may indicate that the NZC information for the TRPs is to be divided between portions of the CSI report 400 so that the quantity of TRPs corresponding to the NZC information in portion 1 is equal or nearly equal to (e.g., within a threshold range of) the quantity of TRPs corresponding to the NZC information in portion 2. In another example (e.g., in Option 1B), the NZC splitting rule may indicate that the NZC information for the TRPs is to be divided between portions of the CSI report 400 so that the NZC information for the strongest TRP (e.g., TRP 1) is included in portion 1 and the NZC information for the remaining TRPs (e.g., TRP 2, TRP 3, TRP 4) is included in portion 2.

The UE may divide the SD basis information for the TRPs according to an SD basis splitting rule that indicates the SD basis information for a TRP is to be included in the same portion of the CSI report 400 as the NZC information for that TRP. So, referring to CSI report 400, the UE may include the SD basis information for set A TRPs in portion 1 based on the NZC information for set A being included in portion 1. Similarly, the UE may include the SD basis information for set B TRPs in portion 2 based on the NZC information for set B being included in portion 2. The SD information for a TRP may include the quantity of SD bases for that TRP and the SD basis selection for that TRP.

The UE may divide the FD basis information for the TRPs according to an FD basis splitting rule that indicates that the FD basis information for the TRPs is to be included in portion 1 of the CSI report 400 if the UE uses an FD-joint codebook (e.g., a mode 2 FD-joint codebook). So, referring to CSI report 400, the UE may include the FD basis information for the TRPs in portion 1 based on the UE using a mode 2 FD-joint codebook.

The UE may divide the FD compensation information for the TRPs according to an FD compensation splitting rule that indicates that the FD compensation information for each TRP is to be included in the same portion of the CSI report 400 as the NZC information for that TRP. So, referring to CSI report 400, the UE may include the FD compensation information for set A TRPs in portion 1 based on the NZC information for set A being included in portion 1. Similarly, the UE may include the FD compensation information for set B TRPs in portion 2 based on the NZC information for set B being included in portion 2.

In some examples, the UE may include additional CSI in portion 1. For example, the UE may include reference amplitude information for the weaker polarization of the two polarizations in portion 1.

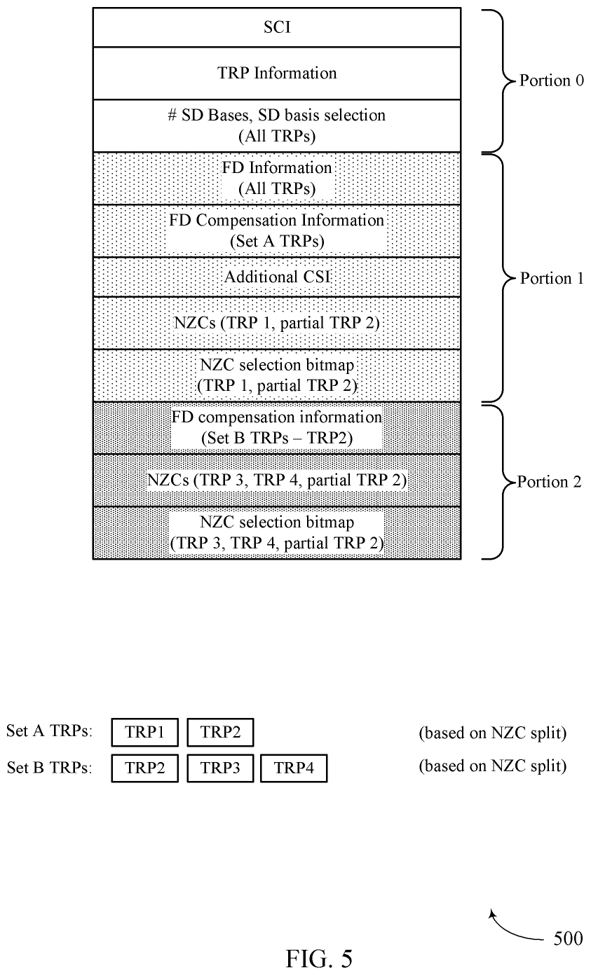

FIG. 5 illustrates an example of a CSI report 500 that supports channel state information reporting for multiple transmission-reception points in accordance with one or more aspects of the present disclosure. The CSI report 500 may be an example of the CSI report 205 as described with reference to FIG. 2. The CSI report 500 may be transmitted by a UE such as a UE 115 or a UE 215 as described with reference to FIGS. 1 and 2, respectively. The UE may be in an mTRP mode in which the UE communicates with multiple TRPs using coherent joint transmission techniques (e.g., Type II CJT). The TRPs may be associated with a common serving cell or network entity and may be co-located or distributed.

The UE may include CSI for the multiple TRPs in different portions of the CSI report 500 according to a third combination of CSI splitting rules. In portion 0 of the CSI report 500, the UE may provide information about how the TRPs map to the CSI that is split between the portions. For example, the UE may include an indication of the TRPs in set A and set B so that the network entity can determine the TRP corresponding to the CSI in each portion. For example, the UE may include in portion 0 one or more bits that indicate which NZC information belongs to which TRP. In some examples, the UE may also include in portion 0 the SCI information for one or more of the TRPs (e.g., the SCI for the strongest TRP).

The UE may divide the NZC information for the TRPs according to an NZC splitting rule. In the provided example, the UE may divide the NZC information for the TRPs so that NZC information corresponding to a first set of the TRPs (e.g., set A) is included in portion 1 and so that NZC information corresponding to a second set of the TRPs (e.g., set B) is included in portion 2. In the given example, set A may include TRP 1 and TRP 2, and set B may include TRP 2, TRP 3, and TRP 4. That is, TRP 2 may be included in both set A and set B. So, in CSI report 500, portion 1 may include: the NZCs and NZC selection bitmaps(s) for TRP 1, and some of the NZCs and part of the NZC selection bitmap(s) for TRP 2. Portion 2 may include: the NZCs and NZC selection bitmaps(s) for TRP 3 and TRP 4, and some of the NZCs and part of the NZC selection bitmap(s) for TRP 2.

The UE may select the TRPs for set A and set B based on the NZC splitting rule. For example, the NZC splitting rule may indicate that the NZC information for the TRPs is to be divided between portions of the CSI report 400 so that the quantity of TRPs corresponding to the NZC information in portion 1 is equal or nearly equal to (e.g., within a threshold range of) the quantity of TRPs corresponding to the NZC information in portion 2. To more evenly the balance of NZCs between portion 1 and portion 2, the UE may include TRP 2 in both sets (so that some NZCs for TRP 2 can be included portion 1 and other NZCs for TRP 2 can be included in portion 2).

In some examples, the NZCs for TRP 2 included in portion 1 may be the highest priority NZCs for TRP 2 and the NZCs for TRP 2 included in portion 2 may be the lowest priority NZCs for TRP 2. The highest priority NZCs across all TRPs may be given by the formula

$$⌈ {K}_{NZ}^{tot} / 2 - RI ⌉$$

and packed (e.g., included) in portion 1, where

$${K}_{NZ}^{tot}$$

is the quantity of NZCs for across all TRPs and RI is the rank indicator for CJT. In this example in FIG. 5, the highest priority

$$⌈ {K}_{NZ}^{tot} / 2 - RI ⌉$$

NZCs happens to include all NZCs of TRP 1 and part of NZCs of TRP 2. The lowest priority NZCs across all TRPs may be given by

$$⌈ {K}_{NZ}^{tot} / 2 ⌉$$

and packed in portion 2.

In some examples, the part of the NZC selection bitmaps(s) for TRP 2 included in portion 1 may include the highest priority bits and the part of the NZC selection bitmap(s) for TRP 2 included in portion 2 may include the lowest priority bits. The highest priority bits of an NZC selection bitmap for a TRP n may be given by the formula

$${\sum }_{n = 1}^{N} 2 {L}_{n} {M}_{n} \cdot RI - {K}_{NZ}^{tot}$$

and packed in portion 1, where Lₙ is quantity of layers for TRP n, Mₙ is the quantity of FD bases selected for TRP n, N is the total number of TRPs associated with this report, RI is the rank indicator for CJT, and

$${K}_{NZ}^{tot}$$

is the quantity of NZCs across all TRPs. The lowest priority bits of an NZC selection bitmap across all TRPs may be given by

$$⌈ {K}_{NZ}^{tot} / 2 ⌉$$

and packed in portion 2.

The UE may divide the SD basis information for the TRPs according to an SD basis splitting rule that indicates the SD basis information for each TRP is to be included in portion 0. So, referring to CSI report 500, the UE may include the SD basis information for TRP 1, TRP 2, TRP 3, and TRP 4 in portion 0. The SD information for a TRP may include the quantity of SD bases for that TRP and the SD basis selection for that TRP.

The UE may divide the FD basis information for the TRPs according to an FD basis splitting rule that indicates that the FD basis information for the TRPs is to be included in portion 1 of the CSI report 500 if the UE uses an FD-joint codebook (e.g., a mode 2 FD-joint codebook). So, referring to CSI report 500, the UE may include the FD basis information for the TRPs in portion 1 based on the UE using a mode 2 FD-joint codebook.

The UE may divide the FD compensation information for the TRPs according to an FD compensation splitting rule that indicates that the FD compensation information for each TRP is to be included in the same portion of the CSI report 500 as the NZC information for that TRP. For a TRP with NZC information in both portions (e.g., TRP 2), the FD compensation information for that TRP may be included in portion 1. So, referring to CSI report 500, the UE may include the FD compensation information for TRP 1 and TRP 2 in portion 1. And the UE may include the FD compensation information for TRP 3 and TRP 4 in portion 2.

In some examples, the UE may include additional CSI in portion 1. For example, the UE may include reference amplitude information for the weaker polarization of the two polarizations in portion 1.

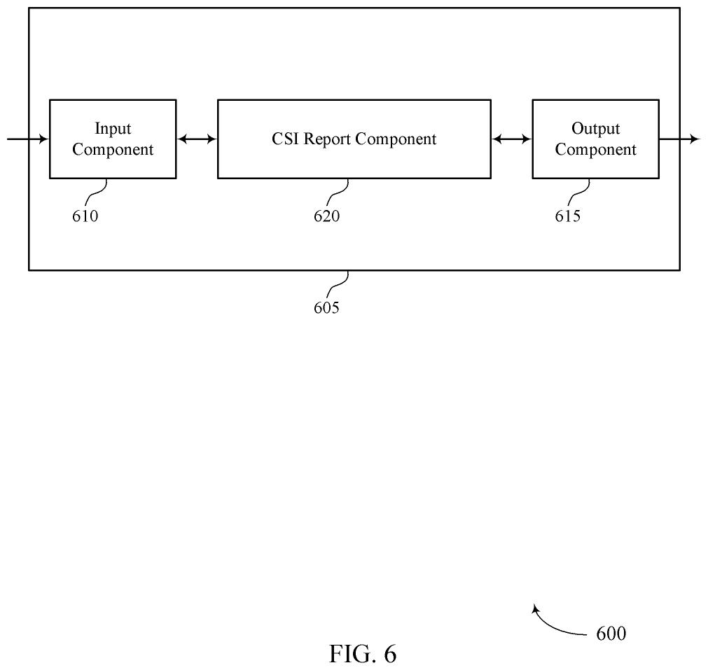

FIG. 6 illustrates a block diagram 600 of a device 605 that supports channel state information reporting for multiple transmission-reception points in accordance with one or more aspects of the present disclosure. The device 605 may be an example of aspects of a wireless device as described herein. The device 605 may include an input component 610, an output component 615, and an CSI report component 620. The device 605 may also include a processor. Each of these components may be in communication with one another (e.g., via one or more buses).

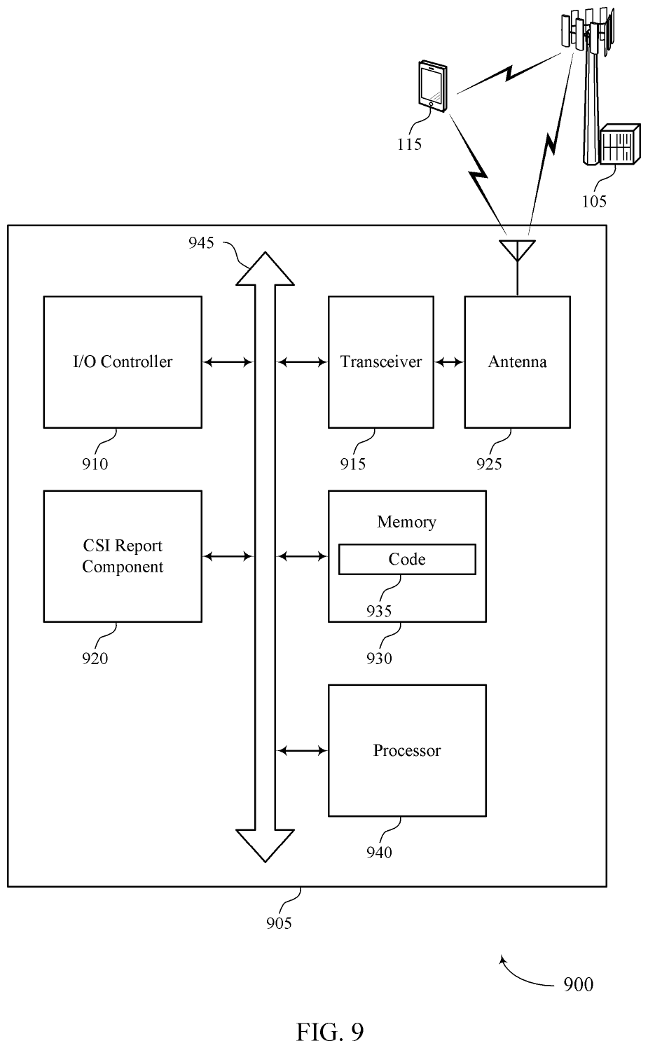

The input component 610 may manage input signals for the device 605. For example, the input component 610 may identify input signals based on an interaction with a modem, a keyboard, a mouse, a touchscreen, or a similar device. These input signals may be associated with user input or processing at other components or devices. In some cases, the input component 610 may utilize an operating system such as iOS®, ANDROID®, MS-DOS®, MS-WINDOWS®, OS/2®, UNIX®, LINUX®, or another known operating system to handle input signals. The input component 610 may send aspects of these input signals to other components of the device 605 for processing. For example, the input component 610 may transmit input signals to the CSI report component 620 to support channel state information reporting for multiple transmission-reception points. In some cases, the input component 610 may be a component of an I/O controller 910 as described with reference to FIG. 9.

The output component 615 may manage output signals for the device 605. For example, the output component 615 may receive signals from other components of the device 605, such as the CSI report component 620, and may transmit these signals to other components or devices. In some specific examples, the output component 615 may transmit output signals for display in a user interface, for storage in a database or data store, for further processing at a server or server cluster, or for any other processes at any number of devices or systems. In some cases, the output component 615 may be a component of an I/O controller 910 as described with reference to FIG. 9.

The CSI report component 620, the input component 610, the output component 615, or various combinations thereof or various components thereof may be examples of means for performing various aspects of channel state information reporting for multiple transmission-reception points as described herein. For example, the CSI report component 620, the input component 610, the output component 615, or various combinations or components thereof may support a method for performing one or more of the functions described herein.

In some examples, the CSI report component 620, the input component 610, the output component 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the CSI report component 620, the input component 610, the output component 615, or various combinations or components thereof may be implemented in code (e.g., as communications management software or firmware) executed by a processor. If implemented in code executed by a processor, the functions of the CSI report component 620, the input component 610, the output component 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the CSI report component 620 may be configured to perform various operations (e.g., receiving, obtaining, monitoring, outputting, transmitting) using or otherwise in cooperation with the input component 610, the output component 615, or both. For example, the CSI report component 620 may receive information from the input component 610, send information to the output component 615, or be integrated in combination with the input component 610, the output component 615, or both to obtain information, output information, or perform various other operations as described herein.

The CSI report component 620 may support wireless communication in accordance with examples as disclosed herein. For example, the CSI report component 620 may be configured as or otherwise support a means for including, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level. The CSI report component 620 may be configured as or otherwise support a means for including, according to the non-zero coefficient splitting rule and in a second portion of the channel state information report, second non-zero coefficient information for a second set of transmission-reception points of the set of multiple transmission-reception points, the second portion associated with a second priority level. The CSI report component 620 may be configured as or otherwise support a means for including, in the channel state information report and according to an additional channel state information splitting rule, additional channel state information for the set of multiple transmission-reception points. The CSI report component 620 may be configured as or otherwise support a means for transmitting the channel state information report corresponding to the set of multiple transmission-reception points.

By including or configuring the CSI report component 620 in accordance with examples as described herein, the device 605 (e.g., a processor controlling or otherwise coupled with the input component 610, the output component 615, the CSI report component 620, or a combination thereof) may support techniques for more efficient utilization of communication resources.

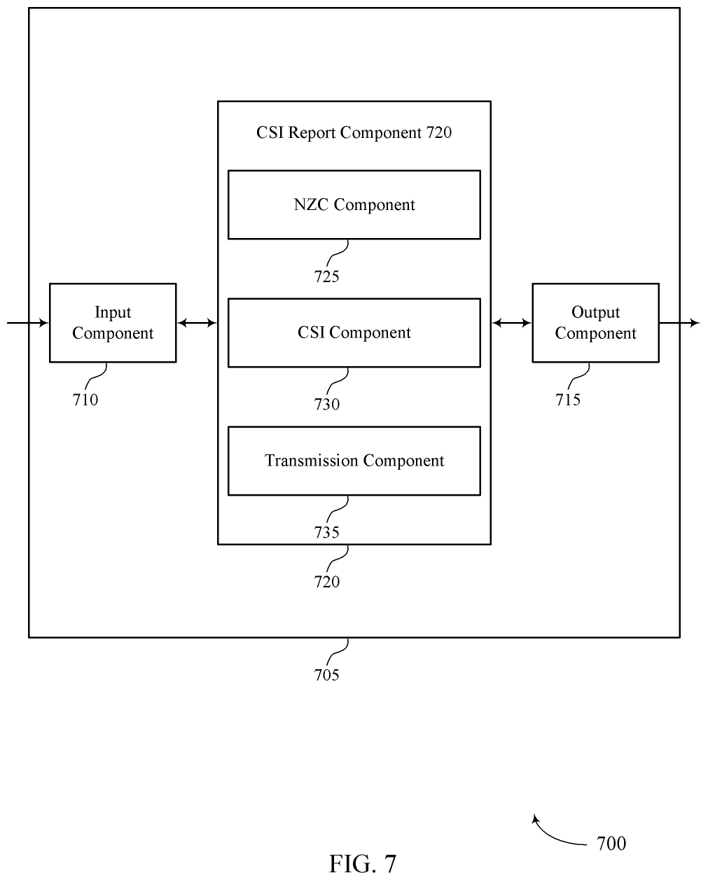

FIG. 7 illustrates a block diagram 700 of a device 705 that supports channel state information reporting for multiple transmission-reception points in accordance with one or more aspects of the present disclosure. The device 705 may be an example of aspects of a device 605 or a wireless device 115 as described herein. The device 705 may include an input component 710, an output component 715, and an CSI report component 720. The device 705 may also include a processor. Each of these components may be in communication with one another (e.g., via one or more buses).

The input component 710 may manage input signals for the device 705. For example, the input component 710 may identify input signals based on an interaction with a modem, a keyboard, a mouse, a touchscreen, or a similar device. These input signals may be associated with user input or processing at other components or devices. In some cases, the input component 710 may utilize an operating system such as iOS®, ANDROID®, MS-DOS®, MS-WINDOWS®, OS/2®, UNIX®, LINUX®, or another known operating system to handle input signals. The input component 710 may send aspects of these input signals to other components of the device 705 for processing. For example, the input component 710 may transmit input signals to the CSI report component 720 to support channel state information reporting for multiple transmission-reception points. In some cases, the input component 710 may be a component of an I/O controller 910 as described with reference to FIG. 9.

The output component 715 may manage output signals for the device 705. For example, the output component 715 may receive signals from other components of the device 705, such as the CSI report component 720, and may transmit these signals to other components or devices. In some specific examples, the output component 715 may transmit output signals for display in a user interface, for storage in a database or data store, for further processing at a server or server cluster, or for any other processes at any number of devices or systems. In some cases, the output component 715 may be a component of an I/O controller 910 as described with reference to FIG. 9.

The device 705, or various components thereof, may be an example of means for performing various aspects of channel state information reporting for multiple transmission-reception points as described herein. For example, the CSI report component 720 may include an NZC component 725, a CSI component 730, a transmission component 735, or any combination thereof. The CSI report component 720 may be an example of aspects of a CSI report component 620 as described herein. In some examples, the CSI report component 720, or various components thereof, may be configured to perform various operations (e.g., receiving, obtaining, monitoring, outputting, transmitting) using or otherwise in cooperation with the input component 710, the output component 715, or both. For example, the CSI report component 720 may receive information from the input component 710, send information to the output component 715, or be integrated in combination with the input component 710, the output component 715, or both to obtain information, output information, or perform various other operations as described herein.

The CSI report component 720 may support wireless communication in accordance with examples as disclosed herein. The NZC component 725 may be configured as or otherwise support a means for including, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level. The NZC component 725 may be configured as or otherwise support a means for including, according to the non-zero coefficient splitting rule and in a second portion of the channel state information report, second non-zero coefficient information for a second set of transmission-reception points of the set of multiple transmission-reception points, the second portion associated with a second priority level. The CSI component 730 may be configured as or otherwise support a means for including, in the channel state information report and according to an additional channel state information splitting rule, additional channel state information for the set of multiple transmission-reception points. The transmission component 735 may be configured as or otherwise support a means for transmitting the channel state information report corresponding to the set of multiple transmission-reception points.

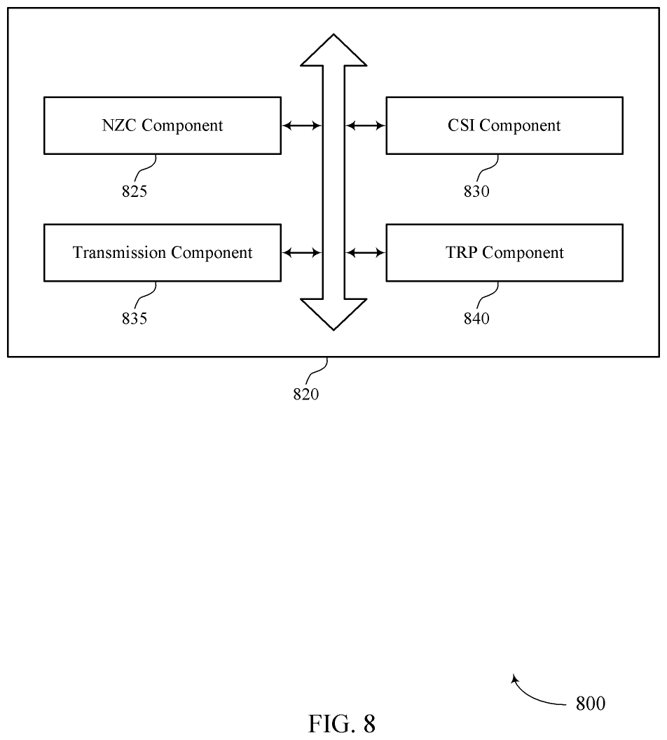

FIG. 8 illustrates a block diagram 800 of an CSI report component 820 that supports channel state information reporting for multiple transmission-reception points in accordance with one or more aspects of the present disclosure. The CSI report component 820 may be an example of aspects of an CSI report component 620, an CSI report component 720, or both, as described herein. The CSI report component 820, or various components thereof, may be an example of means for performing various aspects of channel state information reporting for multiple transmission-reception points as described herein. For example, the CSI report component 820 may include an NZC component 825, a CSI component 830, a transmission component 835, an TRP component 840, or any combination thereof. Each of these components may communicate, directly or indirectly, with one another (e.g., via one or more buses).

The CSI report component 820 may support wireless communication in accordance with examples as disclosed herein. The NZC component 825 may be configured as or otherwise support a means for including, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level. In some examples, the NZC component 825 may be configured as or otherwise support a means for including, according to the non-zero coefficient splitting rule and in a second portion of the channel state information report, second non-zero coefficient information for a second set of transmission-reception points of the set of multiple transmission-reception points, the second portion associated with a second priority level. The CSI component 830 may be configured as or otherwise support a means for including, in the channel state information report and according to an additional channel state information splitting rule, additional channel state information for the set of multiple transmission-reception points. The transmission component 835 may be configured as or otherwise support a means for transmitting the channel state information report corresponding to the set of multiple transmission-reception points.

In some examples, the non-zero coefficient splitting rule indicates that a quantity of transmission-reception points in the first set of transmission-reception points corresponding to the first non-zero coefficient information is to be equal to a quantity of transmission-reception points in the second set of transmission-reception points corresponding to the second non-zero coefficient information.

In some examples, the TRP component 840 may be configured as or otherwise support a means for selecting, based on the non-zero coefficient splitting rule, the first set of transmission-reception points and the second set of transmission-reception points so that the quantity of transmission-reception points in the first set of transmission-reception points is equal to the quantity of transmission-reception points in the second set of transmission-reception points.

In some examples, the non-zero coefficient splitting rule indicates that non-zero coefficient information for a strongest transmission-reception point is to be included in the first portion and that non-zero coefficient information for the remaining transmission-reception points of the set of multiple transmission-reception points is to be included in the second portion.

In some examples, the TRP component 840 may be configured as or otherwise support a means for selecting the strongest transmission-reception point for the first set of transmission-reception points based on the non-zero coefficient splitting rule.

In some examples, the non-zero coefficient splitting rule indicates that a difference between a first quantity of spatial domain bases associated with the first set of transmission-reception points and a second quantity of spatial domain bases associated with the second set of transmission-reception points is to be within a threshold difference.

In some examples, the TRP component 840 may be configured as or otherwise support a means for selecting, based on the non-zero coefficient splitting rule, the first set of transmission-reception points and the second set of transmission-reception points so that the difference between the first quantity of spatial domain bases and the second quantity of spatial domain bases is within the threshold difference.

In some examples, the non-zero coefficient splitting rule indicates that a difference between a first quantity of non-zero coefficients associated with the first set of transmission-reception points and a second quantity of non-zero coefficients associated with the second set of transmission-reception points is to be within a threshold difference.

In some examples, the TRP component 840 may be configured as or otherwise support a means for selecting, based on the non-zero coefficient splitting rule, the first set of transmission-reception points and the second set of transmission-reception points so that the difference between the first quantity of non-zero coefficients and the second quantity of non-zero coefficients is within the threshold difference.

In some examples, the non-zero coefficient splitting rule indicates that some non-zero coefficients associated with a transmission-reception point of the set of multiple transmission-reception points are to be included in the first portion and other non-zero coefficients associated with the transmission-reception point are to be included in the second portion.

In some examples, the first non-zero coefficient information includes non-zero coefficients and a non-zero selection bitmap for the first set of transmission-reception points. In some examples, the second non-zero coefficient information includes non-zero coefficients and a non-zero selection bitmap for the second set of transmission-reception points.

In some examples, the TRP component 840 may be configured as or otherwise support a means for determining that the first set of transmission-reception points have stronger total power of non-zero coefficients than the second set of transmission-reception points, where the first non-zero coefficient information is included in the first portion based on the first of transmission-reception points having stronger total power of non-zero coefficients than the second set of transmission-reception points.

In some examples, the TRP component 840 may be configured as or otherwise support a means for including, in a third portion of the channel state information report that is associated with a third priority level higher than the first priority level and the second priority level, an indication of transmission-reception points included in the first set of transmission-reception points.

In some examples, the TRP component 840 may be configured as or otherwise support a means for including, in a third portion of the channel state information report that is associated with a third priority level higher than the first priority level and the second priority level, an indication of a mapping order of the set of multiple transmission-reception points to the first non-zero coefficient information and the second non-zero coefficient information.

In some examples, the additional channel state information includes spatial domain basis information. In some examples, the additional channel state information splitting rule indicates that the spatial domain basis information is to be included in a third portion of the channel state information report that is associated with a third priority level.

In some examples, the additional channel state information includes first spatial domain basis information for the first set of transmission-reception points and second spatial domain basis information for the second set of transmission-reception points. In some examples, the additional channel state information splitting rule indicates that the first spatial domain basis information is to be included in a same portion of the channel state information report as the first non-zero coefficient information, and indicates that the second spatial domain basis information is to be included in a same portion of the channel state information report as the second non-zero coefficient information.

In some examples, the additional channel state information includes a quantity of spatial domain bases for the set of multiple transmission-reception points. In some examples, the additional channel state information splitting rule indicates that the quantity of spatial domain bases is to be included a third portion of the channel state information report that is associated with a third priority level.

In some examples, the additional channel state information includes second spatial domain basis information for the set of multiple transmission-reception points. In some examples, the additional channel state information splitting rule indicates that the second spatial domain basis information is to be split between the first portion and the second portion.

In some examples, the additional channel state information includes frequency domain basis information for the set of multiple transmission-reception points. In some examples, the additional channel state information splitting rule indicates that the frequency domain basis information is to be included in the first portion if a frequency domain joint codebook is in use.

In some examples, the additional channel state information includes frequency domain basis information for the set of multiple transmission-reception points. In some examples, the additional channel state information splitting rule indicates that the frequency domain basis information is to be included in a third portion of the channel state information report if a port-selection codebook is in use. In some examples, the third portion is associated with a third priority level.

In some examples, the additional channel state information includes frequency domain basis information for the set of multiple transmission-reception points. In some examples, the additional channel state information splitting rule indicates that the frequency domain basis information is to be split between the first portion and the second portion if a frequency domain independent codebook is in use.

In some examples, the additional channel state information includes first frequency domain compensation information for the first set of transmission-reception points and second frequency domain compensation information for the second set of transmission-reception points. In some examples, the additional channel state information splitting rule indicates that the first frequency domain information is to be included in a same portion of the channel state information report as the first non-zero coefficient information and the second frequency domain information is to be included in a same portion of the channel state information report as the second non-zero coefficient information.

FIG. 9 illustrates a diagram of a system 900 including a device 905 that supports channel state information reporting for multiple transmission-reception points in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a CSI report component 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of an output component 615, an output component 715, an input component 610, an input component 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting CRS pattern determination). For example, the device 905 or a component of the device 905 may include a processor 940 and memory 930 coupled with or to the processor 940, the processor 940 and memory 930 configured to perform various functions described herein.

The CSI report component 920 may support wireless communication in accordance with examples as disclosed herein. For example, the CSI report component 920 may be configured as or otherwise support a means for including, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level. The CSI report component 920 may be configured as or otherwise support a means for including, according to the non-zero coefficient splitting rule and in a second portion of the channel state information report, second non-zero coefficient information for a second set of transmission-reception points of the set of multiple transmission-reception points, the second portion associated with a second priority level. The CSI report component 920 may be configured as or otherwise support a means for including, in the channel state information report and according to an additional channel state information splitting rule, additional channel state information for the set of multiple transmission-reception points. The CSI report component 920 may be configured as or otherwise support a means for transmitting the channel state information report corresponding to the set of multiple transmission-reception points.

By including or configuring the CSI report component 920 in accordance with examples as described herein, the device 905 may support techniques for more efficient utilization of communication resources, among other advantages.

In some examples, the CSI report component 920 may be configured to perform various operations (e.g., receiving, monitoring, transmitting) using or otherwise in cooperation with the transceiver 915, the one or more antennas 925, or any combination thereof. Although the CSI report component 920 is illustrated as a separate component, in some examples, one or more functions described with reference to the CSI report component 920 may be supported by or performed by the processor 940, the memory 930, the code 935, or any combination thereof. For example, the code 935 may include instructions executable by the processor 940 to cause the device 905 to perform various aspects of CSI reporting as described herein, or the processor 940 and the memory 930 may be otherwise configured to perform or support such operations.

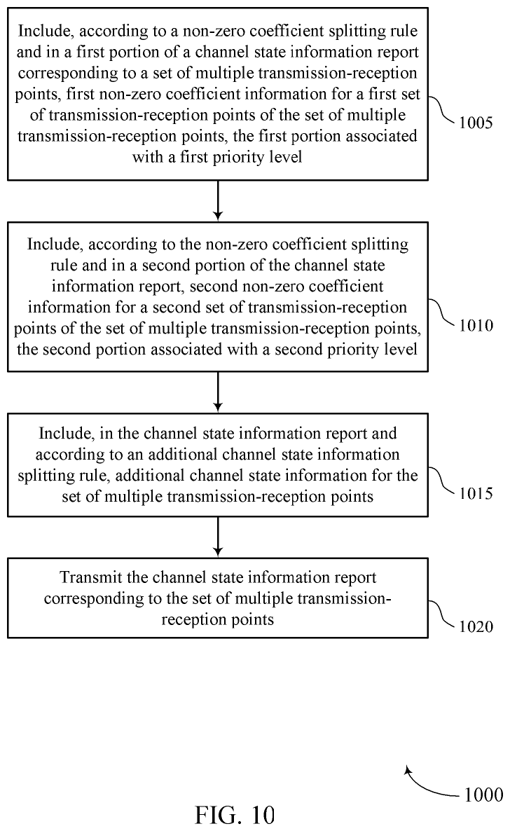

FIG. 10 illustrates a flowchart illustrating a method 1000 that supports channel state information reporting for multiple transmission-reception points in accordance with one or more aspects of the present disclosure. The operations of the method 1000 may be implemented by a wireless device or its components as described herein. For example, the operations of the method 1000 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1005, the method may include including, according to a non-zero coefficient splitting rule and in a first portion of a channel state information report corresponding to a set of multiple transmission-reception points, first non-zero coefficient information for a first set of transmission-reception points of the set of multiple transmission-reception points, the first portion associated with a first priority level. The operations of 1005 may be performed in accordance with examples as disclosed herein. In some examples, aspects of the operations of 1005 may be performed by an NZC component 825 as described with reference to FIG. 8.

At 1010, the method may include including, according to the non-zero coefficient splitting rule and in a second portion of the channel state information report, second non-zero coefficient information for a second set of transmission-reception points of the set of multiple transmission-reception points, the second portion associated with a second priority level. The operations of 1010 may be performed in accordance with examples as disclosed herein. In some examples, aspects of the operations of 1010 may be performed by an NZC component 825 as described with reference to FIG. 8.

At 1015, the method may include including, in the channel state information report and according to an additional channel state information splitting rule, additional channel state information for the set of multiple transmission-reception points. The operations of 1015 may be performed in accordance with examples as disclosed herein. In some examples, aspects of the operations of 1015 may be performed by a CSI component 830 as described with reference to FIG. 8.

At 1020, the method may include transmitting the channel state information report corresponding to the set of multiple transmission-reception points. The operations of 1020 may be performed in accordance with examples as disclosed herein. In some examples, aspects of the operations of 1020 may be performed by a transmission component 835 as described with reference to FIG. 8.

The following provides an overview of aspects of the present disclosure:

Aspect 1: A method for wireless communication, comprising: including, according to a non-zero coefficient splitting rule and in a first portion of a channel state information report corresponding to a plurality of transmission-reception points, first non-zero coefficient information for a first set of transmission-reception points of the plurality of transmission-reception points, the first portion associated with a first priority level; including, according to the non-zero coefficient splitting rule and in a second portion of the channel state information report, second non-zero coefficient information for a second set of transmission-reception points of the plurality of transmission-reception points, the second portion associated with a second priority level; including, in the channel state information report and according to an additional channel state information splitting rule, additional channel state information for the plurality of transmission-reception points; and transmitting the channel state information report corresponding to the plurality of transmission-reception points.

Aspect 2: The method of aspect 1, wherein the non-zero coefficient splitting rule indicates that a quantity of transmission-reception points in the first set of transmission-reception points corresponding to the first non-zero coefficient information is to be equal to a quantity of transmission-reception points in the second set of transmission-reception points corresponding to the second non-zero coefficient information.

Aspect 3: The method of aspect 2, further comprising: selecting, based at least in part on the non-zero coefficient splitting rule, the first set of transmission-reception points and the second set of transmission-reception points so that the quantity of transmission-reception points in the first set of transmission-reception points is equal to the quantity of transmission-reception points in the second set of transmission-reception points.

Aspect 4: The method of any aspect 1, wherein the non-zero coefficient splitting rule indicates that non-zero coefficient information for a strongest transmission-reception point is to be included in the first portion and that non-zero coefficient information for the remaining transmission-reception points of the plurality of transmission-reception points is to be included in the second portion.

Aspect 5: The method of aspect 4, further comprising: selecting the strongest transmission-reception point for the first set of transmission-reception points based at least in part on the non-zero coefficient splitting rule.

Aspect 6: The method of aspect 1, wherein the non-zero coefficient splitting rule indicates that a difference between a first quantity of spatial domain bases associated with the first set of transmission-reception points and a second quantity of spatial domain bases associated with the second set of transmission-reception points is to be within a threshold difference.

Aspect 7: The method of aspect 6, further comprising: selecting, based at least in part on the non-zero coefficient splitting rule, the first set of transmission-reception points and the second set of transmission-reception points so that the difference between the first quantity of spatial domain bases and the second quantity of spatial domain bases is within the threshold difference.

Aspect 8: The method of aspect 1, wherein the non-zero coefficient splitting rule indicates that a difference between a first quantity of non-zero coefficients associated with the first set of transmission-reception points and a second quantity of non-zero coefficients associated with the second set of transmission-reception points is to be within a threshold difference.

Aspect 9: The method of aspect 8, further comprising: selecting, based at least in part on the non-zero coefficient splitting rule, the first set of transmission-reception points and the second set of transmission-reception points so that the difference between the first quantity of non-zero coefficients and the second quantity of non-zero coefficients is within the threshold difference.

Aspect 10: The method of aspect 1, wherein the non-zero coefficient splitting rule indicates that some non-zero coefficients associated with a transmission-reception point of the plurality of transmission-reception points are to be included in the first portion and other non-zero coefficients associated with the transmission-reception point are to be included in the second portion.

Aspect 11: The method of any of aspects 1 through 10, wherein the first non-zero coefficient information comprises non-zero coefficients and a non-zero selection bitmap for the first set of transmission-reception points, and the second non-zero coefficient information comprises non-zero coefficients and a non-zero selection bitmap for the second set of transmission-reception points.

Aspect 12: The method of any of aspects 1 through 11, further comprising: determining that the first set of transmission-reception points have stronger total power of non-zero coefficients than the second set of transmission-reception points, wherein the first non-zero coefficient information is included in the first portion based at least in part on the first of transmission-reception points having stronger total power of non-zero coefficients than the second set of transmission-reception points.

Aspect 13: The method of any of aspects 1 through 12, further comprising: including, in a third portion of the channel state information report that is associated with a third priority level higher than the first priority level and the second priority level, an indication of transmission-reception points included in the first set of transmission-reception points.

Aspect 14: The method of any of aspects 1 through 12, further comprising: including, in a third portion of the channel state information report that is associated with a third priority level higher than the first priority level and the second priority level, an indication of a mapping order of the plurality of transmission-reception points to the first non-zero coefficient information and the second non-zero coefficient information.

Aspect 15: The method of any of aspects 1 through 14, wherein the additional channel state information comprises spatial domain basis information, and the additional channel state information splitting rule indicates that the spatial domain basis information is to be included in a third portion of the channel state information report that is associated with a third priority level.

Aspect 16: The method of any of aspects 1 through 14, wherein the additional channel state information comprises first spatial domain basis information for the first set of transmission-reception points and second spatial domain basis information for the second set of transmission-reception points, and the additional channel state information splitting rule indicates that the first spatial domain basis information is to be included in a same portion of the channel state information report as the first non-zero coefficient information, and indicates that the second spatial domain basis information is to be included in a same portion of the channel state information report as the second non-zero coefficient information.

Aspect 17: The method of any of aspects 1 through 14, wherein the additional channel state information comprises a quantity of spatial domain bases for the plurality of transmission-reception points, and the additional channel state information splitting rule indicates that the quantity spatial domain bases is to be included a third portion of the channel state information report that is associated with a third priority level.

Aspect 18: The method of aspect 17, wherein the additional channel state information comprises second spatial domain basis information for the plurality of transmission-reception points, and the additional channel state information splitting rule indicates that the second spatial domain basis information is to be split between the first portion and the second portion.

Aspect 19: The method of any of aspects 1 through 18, wherein the additional channel state information comprises frequency domain basis information for the plurality of transmission-reception points, and the additional channel state information splitting rule indicates that the frequency domain basis information is to be included in the first portion if a frequency domain joint codebook is in use.

Aspect 20: The method of any of aspects 1 through 18, wherein the additional channel state information comprises frequency domain basis information for the plurality of transmission-reception points, and the additional channel state information splitting rule indicates that the frequency domain basis information is to be included in a third portion of the channel state information report if a port-selection codebook is in use, the third portion is associated with a third priority level.

Aspect 21: The method of any of aspects 1 through 20, wherein the additional channel state information comprises frequency domain basis information for the plurality of transmission-reception points, and the additional channel state information splitting rule indicates that the frequency domain basis information is to be split between the first portion and the second portion if a frequency domain independent codebook is in use.

Aspect 22: The method of any of aspects 1 through 21, wherein the additional channel state information comprises first frequency domain compensation information for the first set of transmission-reception points and second frequency domain compensation information for the second set of transmission-reception points, and the additional channel state information splitting rule indicates that the first frequency domain information is to be included in a same portion of the channel state information report as the first non-zero coefficient information and the second frequency domain information is to be included in a same portion of the channel state information report as the second non-zero coefficient information.

Aspect 23: An apparatus for wireless communication, comprising a processor; memory coupled with the processor; and instructions stored in the memory and executable by the processor to cause the apparatus to perform a method of any of aspects 1 through 22.

Aspect 24: An apparatus for wireless communication, comprising at least one means for performing a method of any of aspects 1 through 22.

Aspect 25: A non-transitory computer-readable medium storing code for wireless communication, the code comprising instructions executable by a processor to perform a method of any of aspects 1 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication, comprising:
including, according to a non-zero coefficient splitting rule and in a first portion of a channel state information report corresponding to a plurality of transmission-reception points, first non-zero coefficient information for a first set of transmission-reception points of the plurality of transmission-reception points, the first portion associated with a first priority level;
including, according to the non-zero coefficient splitting rule and in a second portion of the channel state information report, second non-zero coefficient information for a second set of transmission-reception points of the plurality of transmission-reception points, the second portion associated with a second priority level;
including, in the channel state information report and according to an additional channel state information splitting rule, additional channel state information for the plurality of transmission-reception points; and
transmitting the channel state information report corresponding to the plurality of transmission-reception points.

2. The method of claim 1, wherein the non-zero coefficient splitting rule indicates that a quantity of transmission-reception points in the first set of transmission-reception points corresponding to the first non-zero coefficient information is to be equal to a quantity of transmission-reception points in the second set of transmission-reception points corresponding to the second non-zero coefficient information.

3. The method of claim 2, further comprising:
selecting, based at least in part on the non-zero coefficient splitting rule, the first set of transmission-reception points and the second set of transmission-reception points so that the quantity of transmission-reception points in the first set of transmission-reception points is equal to the quantity of transmission-reception points in the second set of transmission-reception points.

4. The method of claim 1, wherein the non-zero coefficient splitting rule indicates that non-zero coefficient information for a strongest transmission-reception point is to be included in the first portion and that non-zero coefficient information for remaining transmission-reception points of the plurality of transmission-reception points is to be included in the second portion.

5. (canceled)

6. The method of claim 1, wherein the non-zero coefficient splitting rule indicates that a difference between a first quantity of spatial domain bases associated with the first set of transmission-reception points and a second quantity of spatial domain bases associated with the second set of transmission-reception points is to be within a threshold difference.

7. The method of claim 6, further comprising:
selecting, based at least in part on the non-zero coefficient splitting rule, the first set of transmission-reception points and the second set of transmission-reception points so that the difference between the first quantity of spatial domain bases and the second quantity of spatial domain bases is within the threshold difference.

8. The method of claim 1, wherein the non-zero coefficient splitting rule indicates that a difference between a first quantity of non-zero coefficients associated with the first set of transmission-reception points and a second quantity of non-zero coefficients associated with the second set of transmission-reception points is to be within a threshold difference.

9. The method of claim 8, further comprising:
selecting, based at least in part on the non-zero coefficient splitting rule, the first set of transmission-reception points and the second set of transmission-reception points so that the difference between the first quantity of non-zero coefficients and the second quantity of non-zero coefficients is within the threshold difference.

10. The method of claim 1, wherein the non-zero coefficient splitting rule indicates that some non-zero coefficients associated with a transmission-reception point of the plurality of transmission-reception points are to be included in the first portion and other non-zero coefficients associated with the transmission-reception point are to be included in the second portion.

11. The method of claim 1, wherein the first non-zero coefficient information comprises non-zero coefficients and a non-zero selection bitmap for the first set of transmission-reception points, and wherein the second non-zero coefficient information comprises non-zero coefficients and a non-zero selection bitmap for the second set of transmission-reception points.

12. The method of claim 1, further comprising:
determining that the first set of transmission-reception points have stronger total power of non-zero coefficients than the second set of transmission-reception points, wherein the first non-zero coefficient information is included in the first portion based at least in part on the first set of transmission-reception points having stronger total power of non-zero coefficients than the second set of transmission-reception points.

13. The method of claim 1, further comprising:
including, in a third portion of the channel state information report that is associated with a third priority level higher than the first priority level and the second priority level, an indication of transmission-reception points included in the first set of transmission-reception points.

14. (canceled)

15. The method of claim 1, wherein the additional channel state information comprises spatial domain basis information, and wherein the additional channel state information splitting rule indicates that the spatial domain basis information is to be included in a third portion of the channel state information report that is associated with a third priority level.

16. The method of claim 1, wherein the additional channel state information comprises first spatial domain basis information for the first set of transmission-reception points and second spatial domain basis information for the second set of transmission-reception points, and wherein the additional channel state information splitting rule indicates that the first spatial domain basis information is to be included in a same portion of the channel state information report as the first non-zero coefficient information, and indicates that the second spatial domain basis information is to be included in a same portion of the channel state information report as the second non-zero coefficient information.

17. The method of claim 1, wherein the additional channel state information comprises a quantity of spatial domain bases for the plurality of transmission-reception points, and wherein the additional channel state information splitting rule indicates that the quantity of spatial domain bases is to be included a third portion of the channel state information report that is associated with a third priority level.

18. (canceled)

19. The method of claim 1, wherein the additional channel state information comprises frequency domain basis information for the plurality of transmission-reception points, and wherein the additional channel state information splitting rule indicates that the frequency domain basis information is to be included in the first portion if a frequency domain joint codebook is in use.

20. The method of claim 1, wherein the additional channel state information comprises frequency domain basis information for the plurality of transmission-reception points, and wherein the additional channel state information splitting rule indicates that the frequency domain basis information is to be included in a third portion of the channel state information report if a port-selection codebook is in use, the third portion is associated with a third priority level.

21. The method of claim 1, wherein the additional channel state information comprises frequency domain basis information for the plurality of transmission-reception points, and wherein the additional channel state information splitting rule indicates that the frequency domain basis information is to be split between the first portion and the second portion if a frequency domain independent codebook is in use.

22. (canceled)

23. An apparatus for wireless communication, comprising:
a processor;
memory coupled with the processor; and
instructions stored in the memory and executable by the processor to cause the apparatus to:
include, according to a non-zero coefficient splitting rule and in a first portion of a channel state information report corresponding to a plurality of transmission-reception points, first non-zero coefficient information for a first set of transmission-reception points of the plurality of transmission-reception points, the first portion associated with a first priority level;
include, according to the non-zero coefficient splitting rule and in a second portion of the channel state information report, second non-zero coefficient information for a second set of transmission-reception points of the plurality of transmission-reception points, the second portion associated with a second priority level;
include, in the channel state information report and according to an additional channel state information splitting rule, additional channel state information for the plurality of transmission-reception points; and
transmit the channel state information report corresponding to the plurality of transmission-reception points.

24-28. (canceled)

29. An apparatus for wireless communication, comprising:
means for including, according to a non-zero coefficient splitting rule and in a first portion of a channel state information report corresponding to a plurality of transmission-reception points, first non-zero coefficient information for a first set of transmission-reception points of the plurality of transmission-reception points, the first portion associated with a first priority level;
means for including, according to the non-zero coefficient splitting rule and in a second portion of the channel state information report, second non-zero coefficient information for a second set of transmission-reception points of the plurality of transmission-reception points, the second portion associated with a second priority level;
means for including, in the channel state information report and according to an additional channel state information splitting rule, additional channel state information for the plurality of transmission-reception points; and
means for transmitting the channel state information report corresponding to the plurality of transmission-reception points.

30. (canceled)
